(19) United States
(12) Patent Application Publication
(10) Pub. No.: US 2025/0333132 A1
(43) Pub. Date: Oct. 30, 2025

(54) BICYCLE BAG WITH PHONE HOLDER

(71) Applicant: Dongguan Meiluodi Electronics Co., Ltd., Dongguan (CN)

(72) Inventor: Songke Fang, Jieyang (CN)

(21) Appl. No.: 18/788,924

(22) Filed: Jul. 30, 2024

(30) Foreign Application Priority Data
Apr. 30, 2024 (CN) 2024209384561

(51) Int. Cl. B62J 9/21; B62J 9/27; B62J 11/00

(52) U.S. Cl. CPC B62J 9/21; B62J 9/27; B62J 11/00

(57) ABSTRACT

A bicycle bag with the phone holder includes a bicycle bag body, a top shell mounted on the bicycle bag body, and the phone holder mounted on the top shell. The phone holder includes a fixed buckle and a pulling buckle. The fixed buckle is fixedly mounted on the top shell. The pulling buckle is slidbly mounted on the top shell. Clamping holders are disposed on the fixed buckle and the pulling buckle. A rack is disposed on the pulling buckle. A gear engaged with the rack is rotatably mounted in the top shell. A through hole is defined in one side of the top shell. An unlocking switch is rotatably mounted in the through hole. Engaging teeth are disposed on an inner side of the unlocking switch. When the unlocking switch is turned toward one side thereof, the engaging teeth engage with the gear.

### TECHNICAL FIELD

The present disclosure relates to a field of bicycle accessories, and in particular to a bicycle bag with a phone holder.

### BACKGROUND

In order to facilitate cyclists to carry necessary items such as keys, mobile phones, cards, etc. when riding, bicycle bags are created on the market. A conventional bicycle bags is generally mounted on a bicycle frame of a bicycle and comprises a storage pouch opened by a zipper. Pockets are disposed in the storage pouch to facilitate classification and placement of the necessary items.

The conventional bicycle bag on the market generally does not have a phone holder mounted on a surface thereof, which makes a mobile phone inconvenient to use when riding. In order to solve the technical problem, the prior art (e.g., CN patent No CN209467251U, issued on Oct. 8, 2019) discloses a multifunctional bicycle bag. The multifunctional bicycle bag comprises a transparent thermoplastic polyurethanes (TPU) zippered top cover, and a user is able to unzip the transparent TPU zippered top cover to place the mobile phone into the multifunctional bicycle bag for touch screen operation through the transparent TPU zippered top cover. The prior art (e.g., CN patent No.: CN219487624U, issued on Aug. 8, 2023) further discloses a bicycle bag device, in which a phone pocket is disposed on an outer side of a main body of the bicycle bag device to store the mobile phone. In the two disclosures, the user performs operations on the mobile phone through touching a transparent film, which is easy to cause poor contact of a phone screen and is inconvenient to use. In addition, light transmittance of the transparent film is poor, resulting in a reduction in a display effect of the phone screen.

To facilitate the use of the mobile phones during riding, the prior art (e.g., CN patent No.: CN205916245U, issued on Feb. 1, 2017) further discloses a phone mount. A handlebar is clamped in a second clamping space formed between a fixing belt and a back surface of a support plate of the phone mount, so that the phone mount is mounted on the bicycle, and then the mobile phone is fixed to the phone mount through the support plate. The support plate is mainly configured to support the mobile phone, positioning pieces of the phone mount are corresponding to four corners of the mobile phone, and each of the four corners of the mobile phone extends into a corresponding first clamping space, so that the mobile phone is mounted on the phone mount. The prior art (CN patent No.: CN105323344A, issued on Feb. 10, 2016) further discloses a car phone mount which clamps the mobile phone by a universal clamp.

In the prior art, the mobile phone is generally fixed by clamping. There is no limiting structures for the mobile phone after clamping, resulting in unstable of the mobile phone when the user rides on a bumpy road. As a result, the mobile phone may accidentally fall and be damaged. Therefore, it is necessary to provide a phone holder with a lock, and the phone holder must be able to be mounted on a bicycle bag.

### SUMMARY

The present disclosure provides a bicycle bag with a phone holder to solve technical problems in the prior art.

The bicycle bag with the phone holder comprises a bicycle bag body, a top shell fixedly mounted on the bicycle bag body, and the phone holder fixedly mounted on an upper side of the top shell.

The phone holder comprises a fixed buckle and a pulling buckle. The fixed buckle is fixedly mounted on the top shell. The pulling buckle is slidbly mounted on the top shell. Clamping holders are disposed on an inner side of the fixed buckle and an inner side of the pulling buckle.

A rack is disposed on one side of the pulling buckle. A gear is rotatably mounted in the top shell. The gear is engaged with the rack. A through hole is defined in one side of the top shell. An unlocking switch is rotatably mounted in the through hole. Engaging teeth are disposed on an inner side of the unlocking switch. When the unlocking switch is turned toward one side thereof, the engaging teeth engage with the gear.

Furthermore, the engaging teeth are integrally formed at a left end of an inner side of the unlocking switch. When the unlocking switch is turned leftwards, the engaging teeth are engaged with the gear.

Furthermore, a positioning column is disposed on a right end of an inner side of the unlocking switch. A first end of a limiting spring is sleeved on the positioning column. A second end of the limiting spring abuts against an inner side of the top shell. When the unlocking switch is turned leftwards or turned rightwards, a position of the unlocking switch is limited by the limiting spring.

Furthermore, an upper cover is fixedly mounted on the top shell through first screws. The upper cover covers the pulling buckle. Sliding grooves are defined in a bottom side of the upper cover. A left end of each of the sliding grooves extends out of a left side edge of the upper cover. Horizontal ribs are disposed on an upper side of the pulling buckle. The horizontal ribs are one-to-one slidbly mounted in the sliding grooves.

Furthermore, at least one reset tension spring is mounted between the pulling buckle and the top shell.

Furthermore, the at least one reset tension spring comprises two reset tension springs. Two spring hooks are disposed on a bottom side of the pulling buckle. Two support columns are disposed on the bottom side of the upper cover. A left end of each of the two reset tension springs is hooked on a corresponding one of the spring hooks. A right end of each of the two reset tension springs is sleeved on a corresponding one of the support columns.

Furthermore, a lower cover is mounted on a bottom side of the top shell by second screws. The gear and the unlocking switch are rotatably mounted between the top shell and the lower cover.

Furthermore, rubber pads are respectively fixedly mounted on the clamping holders.

Furthermore, the bicycle bag body comprises a bottom shell, an inner support, and a zipper. The inner support covers the bottom shell and is mounted on the bottom shell. The zipper is sewn and fixed between the bottom shell and the top shell.

Furthermore, a mounting hole is defined in an upper side of the inner support, and the lower cover is mounted in the mounting hole.

Compared with the prior art, in the present disclosure, the phone holder is mounted on the top shell of the bicycle bag body. When using the phone holder, the unlocking switch is first turned rightwards to separate the engaging teeth and the rack, and then the mobile phone is placed between the fixed buckle and the pulling buckle. Then, the unlocking switch is turned leftwards to engage the card teeth with the rack, thereby limiting movement of the pulling buckle. At this time, the mobile phone is effectively prevented from detaching from the phone holder. Even if the bicycle is traveling on a very bumpy road, the pulling buckle does not loosen, thereby effectively fixing the mobile phone. Compared with a conventional method of fixing the mobile phone by elastic clamping, the phone holder of the present disclosure has higher stability. Moreover, a user does not need to operate the mobile phone through a transparent film, so a display effect and touch sensitivity of a screen of the mobile phone are not affected, and the mobile phone is prevented from accidentally falling and being damaged.

Additional aspects and advantages of the present disclosure are given in part in the following description and in part will be obvious from the following description or learned through practice of the present disclosure.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a schematic diagram of a bicycle bag with a phone holder according to one embodiment of the present disclosure.

FIG. 2 is an exploded schematic diagram of the bicycle bag with the phone holder according to one embodiment of the present disclosure, where the phone holder is separated from a bicycle bag body.

FIG. 3 is another exploded schematic diagram of the bicycle bag with the phone holder shown in FIG. 2.

FIG. 4 is an exploded schematic diagram of the bicycle bag with the phone holder according to one embodiment of the present disclosure.

FIG. 5 is another exploded schematic diagram of the bicycle bag with the phone holder shown in FIG. 4, where the phone holder is removed.

FIG. 6 is an exploded schematic diagram of the phone holder according to one embodiment of the present disclosure.

FIG. 7 is an exploded schematic diagram showing a gear and a unlocking switch.

FIG. 8 is another exploded schematic diagram showing the gear and the unlocking switch.

FIG. 9 is a schematic diagram of the gear and the unlocking switch shown in a configuration of use.

### REFERENCE NUMBERS IN THE DRAWINGS

1—bicycle bag body; 1.1—bottom shell; 1.2—inner support; 1.3—zipper; 2—top shell; 3—phone holder; 3.1—fixed buckle; 3.2—pulling buckle; 4—clamping holder; 5—rack; 6—gear; 7—through hole; 8—unlocking switch; 9—engaging teeth 10—positioning column; 11—limiting spring; 12—upper cover; 13—sliding groove; 14—horizontal rib; 15—reset tension spring; 16—spring hook; 17—support column; 18—lower cover; 19—rubber pad; 20—mounting hole; 21—fastener; 22—strap.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments.

The components of the embodiments of the present disclosure generally described and illustrated in the figures herein may be arranged and designed in a variety of different configurations. Therefore, the following detailed description of the embodiments of the present disclosure provided in the accompanying drawings is not intended to limit the protection scope of the present disclosure, but merely represents selected embodiments of the present disclosure. Based on the embodiments in the present disclosure, all other embodiments obtained by those skilled in the art without creative work are within the protection scope of the present disclosure.

It should be noted that in the description of the present disclosure, terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present disclosure and the simplification of the description rather than to indicate or imply that the indicated device or element must have a specific direction or constructed and operated in a specific direction, and therefore, shall not be understood as a limitation to the present disclosure. In addition, terms such as “first”, “second”, and “third” are only used for the purpose of description, rather than being understood to indicate or imply relative importance.

It should be noted in the description of the present disclosure that, unless otherwise regulated and defined, terms such as “installation,” “bonded,” and “connection” shall be understood in broad sense, and for example, may refer to fixed connection or detachable connection or integral connection, may refer to mechanical connection or electrical connection, and may refer to direct connection or indirect connection through an intermediate medium or inner communication of two elements. For those of ordinary skill in the art, the meanings of the above terms in the present disclosure may be understood according to concrete conditions.

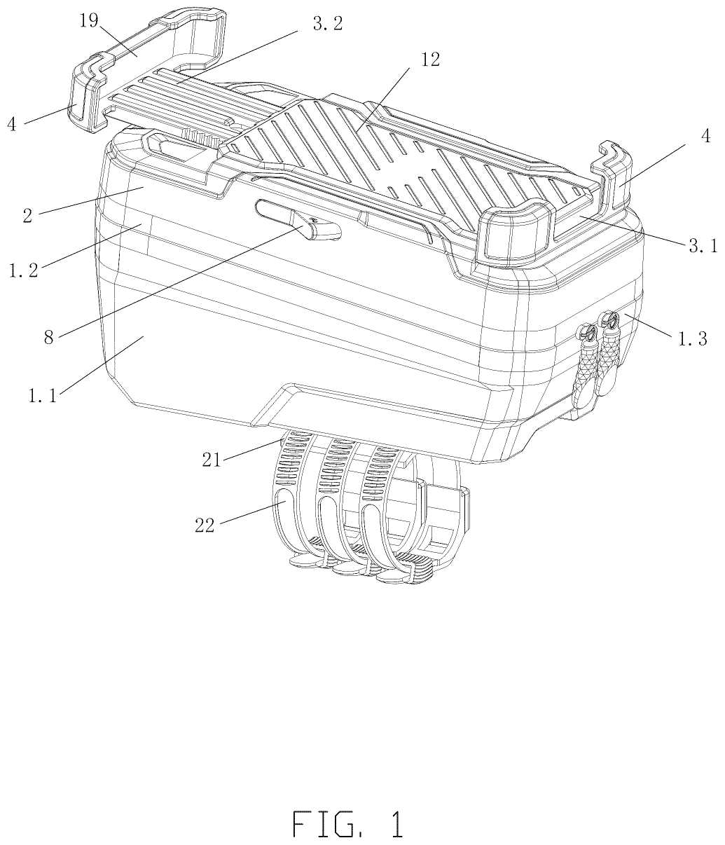

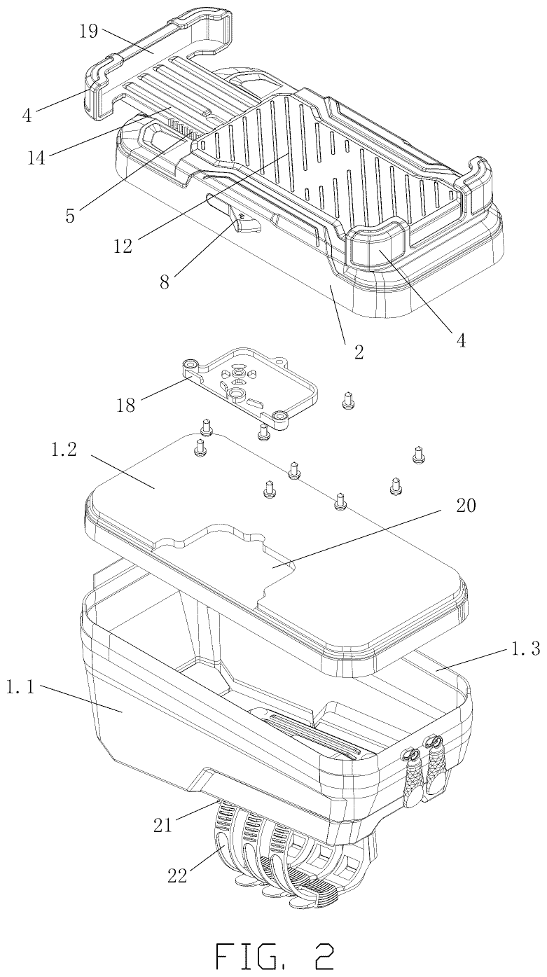

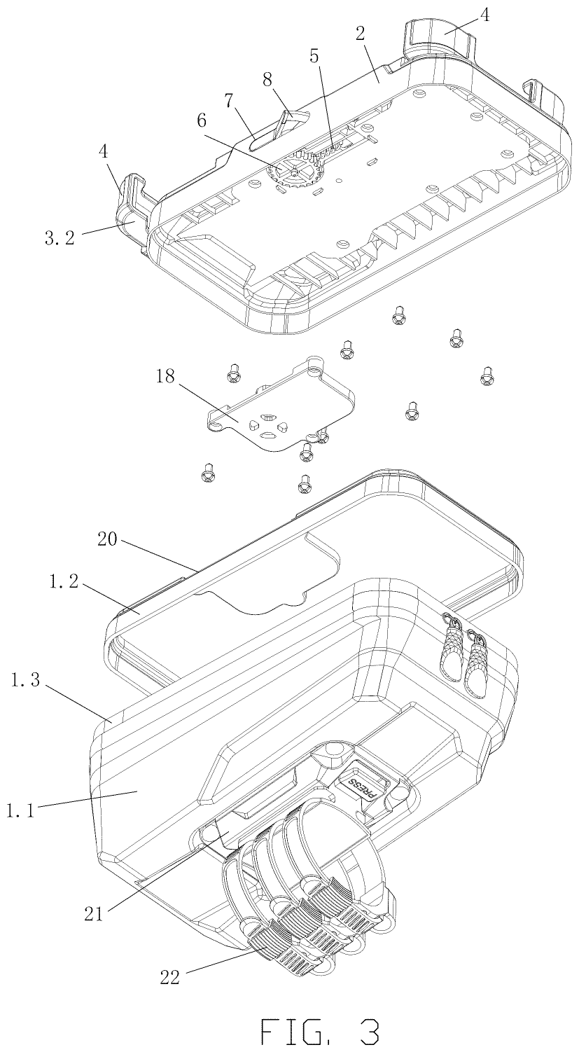

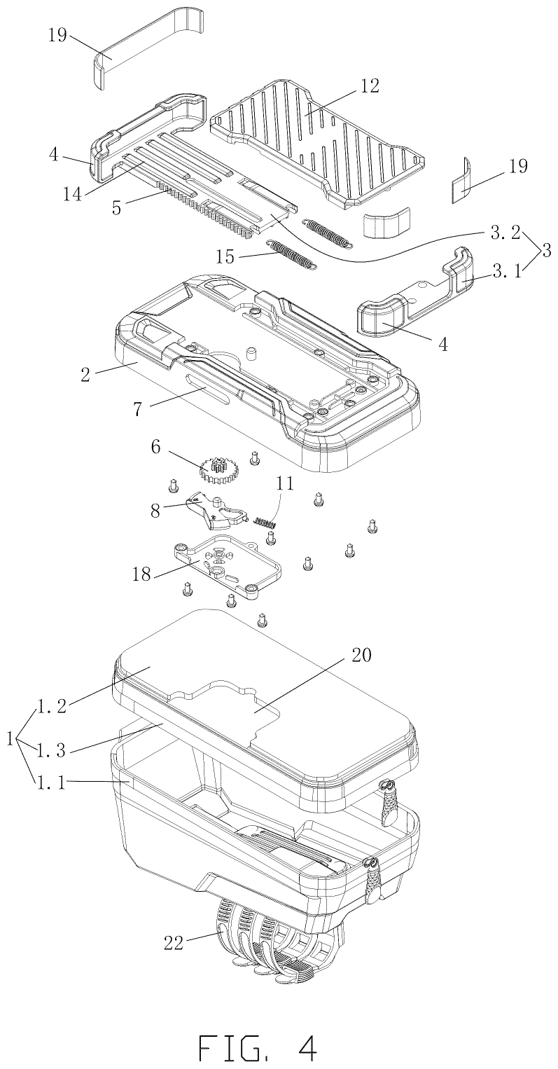

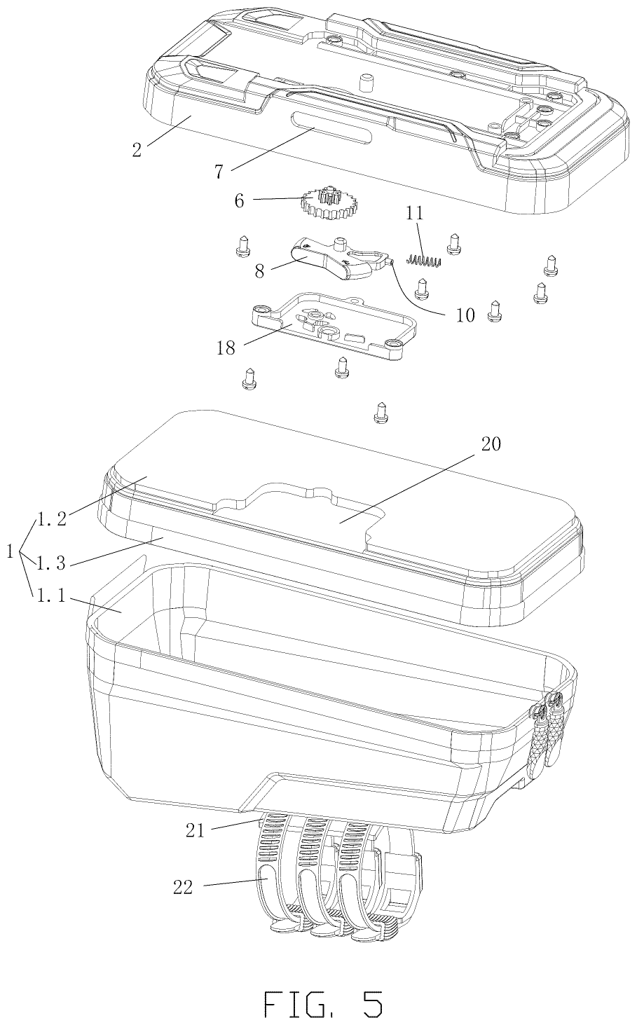

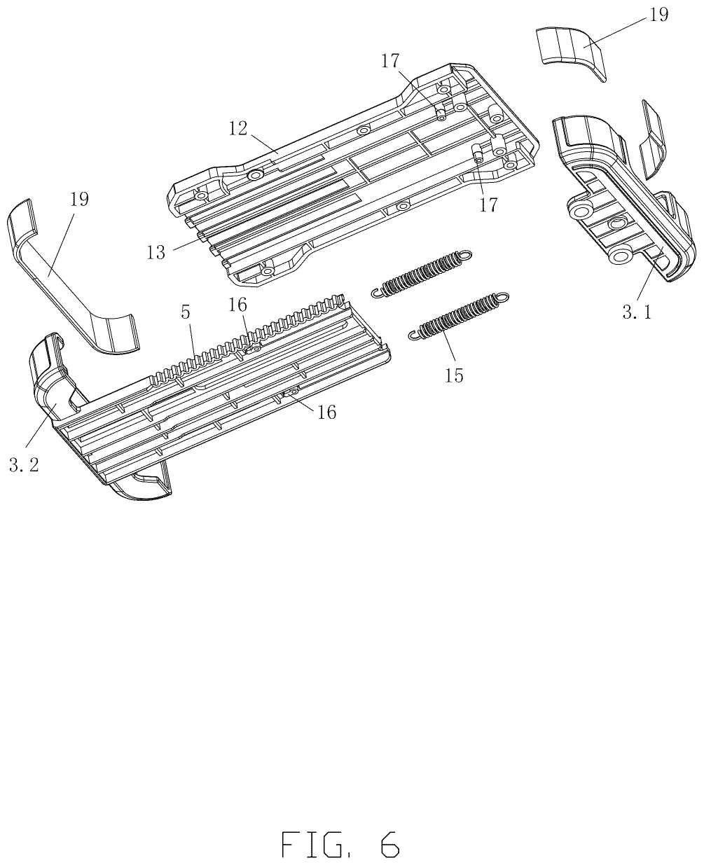

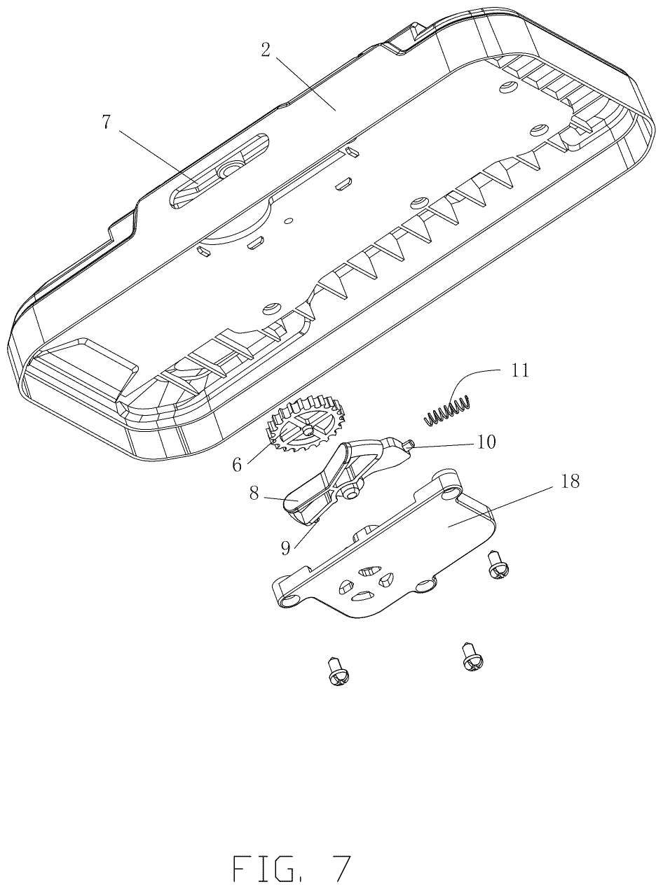

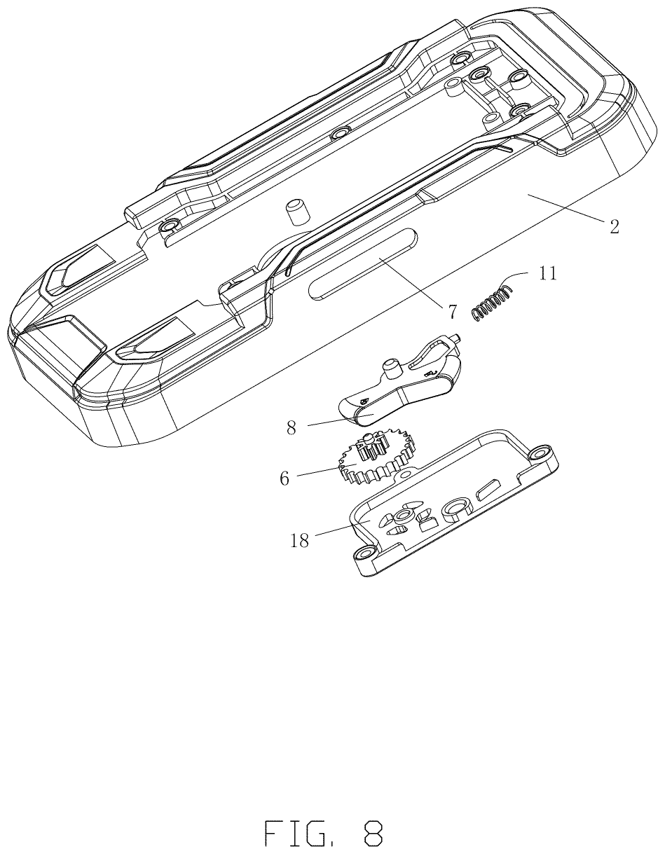

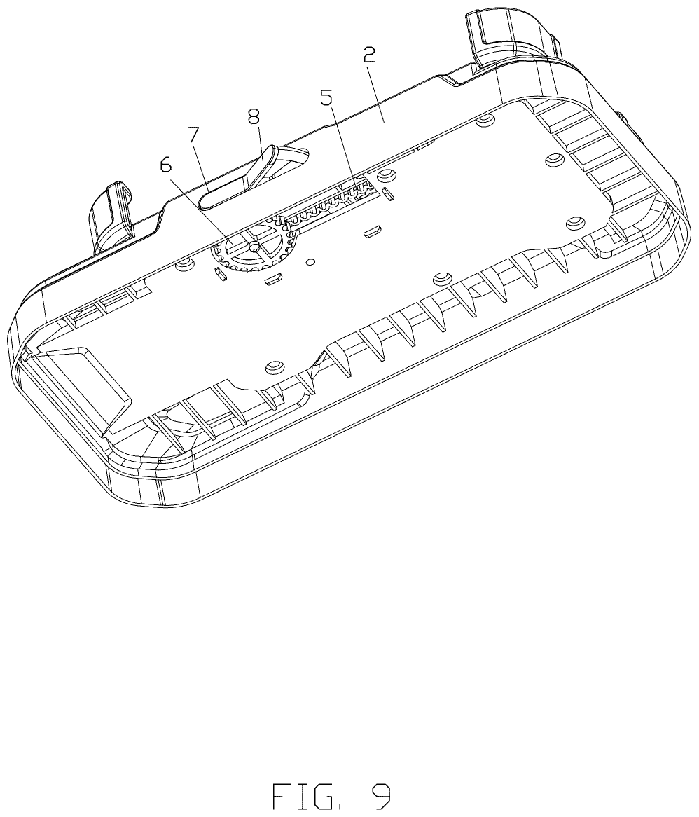

As shown in FIGS. 1-9, a bicycle bag with a phone holder 3 of the present disclosure comprises a bicycle bag body 1, a top shell 2 fixedly mounted on the bicycle bag body 1, and the phone holder 3 fixedly mounted on an upper side of the top shell 2.

The phone holder 3 comprises a fixed buckle 3.1 and a pulling buckle 3.2. The fixed buckle 3.1 is fixedly mounted on the top shell 2. The pulling buckle 3.2 is slidbly mounted on the top shell 2. Clamping holders 4 are disposed on an inner side of the fixed buckle 3.1 and an inner side of the pulling buckle 3.2.

A rack 5 is disposed on one side of the pulling buckle 3.2. A gear 6 is rotatably mounted in the top shell 2. The gear 6 is engaged with the rack 5. A through hole 7 is defined in one side of the top shell 2. An unlocking switch 8 is rotatably mounted in the through hole 7. Engaging teeth 9 are disposed on an inner side of the unlocking switch 8. When the unlocking switch 8 is turned toward one side thereof, the engaging teeth 9 engage with the gear 6.

A working principle is as follow:

The phone holder 3 is mounted on the top shell 2 of the bicycle bag body 1. When using the phone holder 3, the unlocking switch 8 is first turned rightwards to separate the engaging teeth 9 and the rack 5, and then a mobile phone is placed between the fixed buckle 3.1 and the pulling buckle 3.2. Then, the unlocking switch 8 is turned leftwards to engage the card teeth with the rack 5, thereby limiting movement of the pulling buckle 3.2. At this time, the mobile phone is effectively prevented from detaching from the phone holder 3. Even if the bicycle is traveling on a very bumpy road, the pulling buckle 3.2 does not loosen, thereby effectively fixing the mobile phone. Compared with a conventional method of fixing the mobile phone by elastic clamping, the phone holder 3 of the present disclosure has higher stability. Moreover, a user does not need to operate the mobile phone through a transparent film, so a display effect and touch sensitivity of a screen of the mobile phone are not affected, and the mobile phone is prevented from accidentally falling and being damaged.

Furthermore, the engaging teeth 9 are integrally formed at a left end of an inner side of the unlocking switch 8. When the unlocking switch 8 is turned leftwards, the engaging teeth 9 are engaged with the gear 6. When the unlocking switch 8 is turned leftward, a position of the pulling buckle 3.2 is limited, thereby locking the mobile phone in the phone holder 1. When the unlocking switch 8 is turned rightwards, the engaging teeth 9 are separates from the gear 6, thereby allowing the pulling buckle 3.2 to continue to be pulled to move, so that the mobile phone is allowed to be taken out of the phone holder 3 by turning the unlocking switch 8 rightwards.

Furthermore, a positioning column 10 is disposed on a right end of an inner side of the unlocking switch 8. A first end of a limiting spring 11 is sleeved on the positioning column 10. A second end of the limiting spring 11 abuts against an inner side of the top shell 2. When the unlocking switch 8 is turned leftwards or turned rightwards, a position of the unlocking switch 8 is limited by the limiting spring. The unlocking switch 8 is automatically limited after being pushed rightwards or leftwards, and the unlocking switch 8 does not unlock due to road bumps, thereby ensuring firmness of the mobile phone.

Furthermore, an upper cover 12 is fixedly mounted on the top shell 2 through first screws. The upper cover 12 covers the pulling buckle 3.2. Sliding grooves 13 are defined in a bottom side of the upper cover 12. A left end of each of the sliding grooves 13 extends out of a left side edge of the upper cover 12. Horizontal ribs 14 are disposed on an upper side of the pulling buckle 3.2. The horizontal ribs 14 are one-to-one slidbly mounted in the sliding grooves 13. In this way, sliding of the pulling buckle 3.2 is smooth and stable.

Furthermore, at least one reset tension spring is mounted between the pulling buckle 3.2 and the top shell 2.

After the mobile phone is mounted, the at least one reset tension spring 15 drives the pulling buckle 3.2 to lock the mobile phone, so that the mobile phone is automatically clamped between the fixed buckle 3.1 and the pulling buckle 3.2. When the mobile phone is placed between the fixed buckle 3.1 and the pulling buckle 3.2, the unlocking switch 8 is turned to lock the mobile phone, which ensures stability of the mobile phone.

Furthermore, the at least one reset tension spring 15 comprises two reset tension springs 15. Two spring hooks 16 are disposed on a bottom side of the pulling buckle 3.2. Two support columns 17 are disposed on the bottom side of the upper cover 12. A left end of each of the two reset tension springs 15 is hooked on a corresponding one of the spring hooks 16. A right end of each of the two reset tension springs 15 is sleeved on a corresponding one of the support columns 17. In this way, the two reset tension springs 15 are stably mounted.

Furthermore, a lower cover 18 is mounted on a bottom side of the top shell 2 by second screws. The gear 6 and the unlocking switch 8 are rotatably mounted between the top shell 2 and the lower cover 18. In this way, the gear 6 and the unlocking switch 8 are stably mounted.

Furthermore, rubber pads 19 are respectively fixedly mounted on the clamping holders 4. The rubber pads 19 prevent the clamping holders 4 on the fixed buckle 3.1 and the pulling buckle 3.2 from scratching the mobile phone.

Furthermore, the bicycle bag body 1 comprises a bottom shell 1.1, an inner support 1.2, and a zipper 1.3. The inner support 1.2 covers the bottom shell 1.1 and is mounted on the bottom shell 1.1. The zipper 1.3 is sewn and fixed between the bottom shell 1.1 and the top shell 2. The zipper 1.3 is configured to open the bicycle bag body 1. The bicycle bag body 1 is configured to store items such as keys, watches, earphones, etc., which is convenient for practical use.

Furthermore, a mounting hole 20 is defined in an upper side of the inner support 1.2, and the lower cover 18 is mounted in the mounting hole 20, so that the inner support 1.2 and the lower cover 18 do not affect each other.

Furthermore: a fastener 21 is fixedly mounted on a bottom side of the bottom shell 1.1 through rivets. Straps 22 are fixedly mounted on the fastener 21. The bicycle bag body 1 is connected to a bicycle frame (e.g., a front handlebar) through the fastener 21 and the straps 22, which facilitate mounting of the bicycle bag body 1 on the bicycle.

In addition to being applicable to the bicycle, the present disclosure is also allowed to be mounted on a vehicle such as an electromobile, a motorcycle, a tricycle, etc. Therefore, the bicycle bag has a wide range of applications and is conducive to popularization and use.

The embodiments are not intended to limit the shape, material, structure, etc. of the present disclosure in any form, and any simple modifications, equivalent changes and modifications made to the above embodiments according to the technology of the present disclosure fall within the protection scope of the technical solutions of the present disclosure.

What is claimed is:

1. A bicycle bag with a phone holder, comprising:
a bicycle bag body,
a top shell fixedly mounted on the bicycle bag body, and
a phone holder fixedly mounted on an upper side of the top shell;
wherein the phone holder comprises a fixed buckle and a pulling buckle; the fixed buckle is fixedly mounted on the top shell; the pulling buckle is slidbly mounted on the top shell; clamping holders are disposed on an inner side of the fixed buckle and an inner side of the pulling buckle;
wherein a rack is disposed on one side of the pulling buckle; a gear is rotatably mounted in the top shell; the gear is engaged with the rack; a through hole is defined in one side of the top shell; an unlocking switch is rotatably mounted in the through hole; engaging teeth are disposed on an inner side of the unlocking switch; when the unlocking switch is turned toward one side thereof, the engaging teeth engage with the gear.

2. The bicycle bag with the phone holder according to claim 1, wherein the engaging teeth are integrally formed at a left end of an inner side of the unlocking switch; when the unlocking switch is turned leftwards, the engaging teeth are engaged with the gear.

3. The bicycle bag with the phone holder according to claim 1, wherein a positioning column is disposed on a right end of an inner side of the unlocking switch; a first end of a limiting spring is sleeved on the positioning column; a second end of the limiting spring abuts against an inner side of the top shell; when the unlocking switch is turned leftwards or turned rightwards, a position of the unlocking switch is limited by the limiting spring.

4. The bicycle bag with the phone holder according to claim 1, wherein an upper cover is fixedly mounted on the top shell through first screws; the upper cover covers the pulling buckle; sliding grooves are defined in a bottom side of the upper cover; a left end of each of the sliding grooves extends out of a left side edge of the upper cover; horizontal ribs are disposed on an upper side of the pulling buckle; the horizontal ribs are one-to-one slidbly mounted in the sliding grooves.

5. The bicycle bag with the phone holder according to claim 4, wherein at least one reset tension spring is mounted between the pulling buckle and the top shell.

6. The bicycle bag with the phone holder according to claim 5, wherein the at least one reset tension spring comprises two reset tension springs; two spring hooks are disposed on a bottom side of the pulling buckle; two support columns are disposed on the bottom side of the upper cover; a left end of each of the two reset tension springs is hooked on a corresponding one of the spring hooks; a right end of each of the two reset tension springs is sleeved on a corresponding one of the support columns.

7. The bicycle bag with the phone holder according to claim 1, wherein a lower cover is mounted on a bottom side of the top shell by second screws; the gear and the unlocking switch are rotatably mounted between the top shell and the lower cover.

8. The bicycle bag with the phone holder according to claim 1, wherein rubber pads are respectively fixedly mounted on the clamping holders.

9. The bicycle bag with the phone holder according to claim 7, wherein the bicycle bag body comprises a bottom shell, an inner support, and a zipper; the inner support covers the bottom shell and is mounted on the bottom shell; the zipper is sewn and fixed between the bottom shell and the top shell.

10. The bicycle bag with the phone holder according to claim 9, wherein a mounting hole is defined in an upper side of the inner support, and the lower cover is mounted in the mounting hole.
